(19) United States
(12) Patent Application Publication
(10) Pub. No.: US 2006/0223973 A1
(43) Pub. Date: Oct. 5, 2006

(54) Method of forming a polyethercarbonate polyol

(75) Inventors: Werner Hinz, Grosse Ile, MI (US); Edward M. Dexheimer, Grosse Ile, MI (US); John Broge, Wyandotte, MI (US); Raymond Neff, Northville, MI (US); Theodore M. Smiecinski, Woodhaven, MI (US)

Correspondence Address: BASF AKTIENGESELLSCHAFT, CARL-BOSCH STRASSE 38, 67056 LUDWIGSHAFEN, LUDWIGSHAFEN, 69056, DE

(73) Assignee: BASF Corporation

(21) Appl. No.: 11/092,098

(22) Filed: Mar. 29, 2005

(51) Int. Cl. C08G 64/00

(52) U.S. Cl. 528/196

(57) ABSTRACT

A polyethercarbonate polyol includes polyethercarbonate segments, polycarbonate segments, and polyether segments. A method of forming the polyethercarbonate polyol provides a catalyst, including a multimetal cyanide compound, and reacts an H-functional initiator, an alkylene oxide, and carbon dioxide in the presence of the multimetal cyanide compound to form the polyethercarbonate polyol. Amounts of each segment in the polyethercarbonate polyol are selectively controlled.

### TECHNICAL FIELD

The present invention generally relates to a method of forming a polyethercarbonate (PEC) polyol. More specifically, the present invention relates to a method of forming a PEC polyol where a composition of the PEC polyol that is formed is controlled.

### BACKGROUND OF THE INVENTION

Polyethercarbonate (PEC) polyols are known in the art. PEC polyols are utilized, in conjunction with a cross-linking agent, such as an isocyanate, to produce polyurethane polymers. The polyurethane polymers can be foamed or non-foamed, i.e., elastomeric. Generally, PEC polyols are formed as a polymerization reaction product of an H-functional initiator, an alkylene oxide, and carbon dioxide.

The PEC polyols include polyethercarbonate segments. More specifically, the carbon dioxide is incorporated, along with an excess of the alkylene oxide, into the backbone of the polyol chain to establish these polyethercarbonate segments. PEC polyols may also include polycarbonate segments and polyether segments.

Various methods of forming PEC polyols are also known in the art. Generally, these methods utilize a catalyst system and polymerize the H-functional initiator, the alkylene oxide, and carbon dioxide in the presence of the catalyst system. A number of catalyst systems have been proposed for use to form PEC polyols. A wide array of difficulties have been realized in methods that rely on these conventional catalyst systems.

One difficulty has been low catalyst activity. A second difficulty has been low productivity, realized as a decreased rate of reaction and/or a low PEC polyol:catalyst ratio. The decreased rate of reaction is, in part, due to a generally low reactivity of carbon dioxide with the catalyst systems to date. More specifically, a decreasing rate of reaction has been observed with increasing carbon dioxide pressure (refer to L. Chen, Rate of Regulated Copolymerization Involving CO₂, J Natural Gas Chemistry, 1998,7,149-156). As a result of this decreasing rate of reaction, very high levels of catalysts are required to form a PEC polyol with any significant amount of carbon dioxide incorporated into the polyol. A further difficulty has been the generally high rate of formation of cyclic byproducts, such as propylene carbonate when the alkylene oxide that is utilized is propylene oxide. Yet a further difficulty has been an inability to effectively control the polymerization of the alkylene oxide and the carbon dioxide. This inability to effectively control the polymerization of the alkylene oxide and the carbon dioxide frequently results in PEC polyols that have high polydispersity and are very viscous, which, ultimately, limits the processability of the PEC polyols. Furthermore, the inability to effectively control the co-polymerization of the alkylene oxide and the carbon dioxide leads to the uncontrollable formation of polycarbonate and polyether segments which is undesirable and can contribute to physical property deficiencies in the polyurethane polymers produced from PEC polyols having the uncontrolled polycarbonate and polyether segments.

In an attempt to more effectively control the polymerization and also to increase the incorporation of carbon dioxide into the backbone of the polyol chain, double metal cyanide (DMC) catalysts have, more recently, been used in place of the conventional catalyst systems. Examples of such are disclosed in U.S. Pat. Nos. 4,472,560; 4,500,704; 4,826,887; 4,826,952; and 4,826,953. However, use of these DMC catalysts still presents several of the difficulties outlined above. For example, to date, methods that utilize catalyst systems with DMC catalysts still do not effectively control the polymerization of the alkylene oxide and the carbon dioxide.

Aside from the PEC polyols, polycarbonate (PC) polyols are also known in the art. PC polyols are copolymers of alkylene oxide and carbon dioxide and only include polycarbonate segments. As such, PC polyols are characterized, more specifically, by the presence of regular, alternating alkylene oxide and carbon dioxide monomer units. PC polyols are expensive and, like the PEC polyols of the prior art described above, have a high viscosity which limits the processability of the PC polyols. In fact, even at a low molecular weight, for example a weight-average molecular weight of approximately 1000, many PC polyols are already waxy solids at room temperature. Examples of these types of PC polyols include Duracarb® PC Polyols available from PPG, Industries and Permuthane® PC Polyols available from ICI. Furthermore, while PC polyols convey certain desirable physical properties to the polyurethane polymers, the PC polyols also contribute to the deterioration of other important physical properties.

Due to the various difficulties associated with the methods of forming PEC polyols of the prior art, including those described above, there remains an opportunity to establish a new and unique method of forming a PEC polyol having a controlled composition.

### SUMMARY OF THE INVENTION

The method of the present invention forms a polyether carbonate (PEC) polyol. The method provides a catalyst including a multimetal cyanide compound. The method also includes reacting an H-functional initiator, an alkylene oxide, and carbon dioxide in the presence of the multimetal cyanide compound in a reactor to form the polyethercarbonate polyol. The polyethercarbonate polyol comprises the general formula [A]ₐ[B]_{b}[C]_{c}. A is a polyethercarbonate segment, B is a polycarbonate segment, and C is a polyether segment. Each of A, B, and C are defined by the presence of CH₃ group resonances of alkylene oxide-based ether chain units at separate peaks in a ¹H NMR spectrum of the polyethercarbonate polyol. Further, a is a value from 1-98, b is a value from 0-60, and c is a value from 0-98 so long as b and c are both not equal to 0. Finally, the values for each of a, b, and c are in area % based on the presence of the CH₃ group resonances in the ¹H NMR spectrum and on the integration of the area under the respective peaks that are present in the ¹H NMR spectrum. The method further includes selectively controlling the value of a, b, or c.

By selectively controlling these values, the method of the present invention is able to form the PEC polyol, in a controlled manner, such that the PEC polyol will have a defined composition, i.e., defined amounts of the polyethercarbonate segments, polycarbonate segments, and polyether segments, in its microstructure. At the same time, this method reduces the extent of formation of undesirable cyclic byproducts (alkylene carbonates). Furthermore, as a result of selectively controlling the values and, consequently, the polyethercarbonate, polycarbonate, and polyether segments, carbon dioxide can be more effectively incorporated into the PEC polyol. That is, carbon dioxide can be strategically, rather than uncontrollably and randomly, incorporated into the PEC polyol. As a result, the method of the present invention is improved in that it enables the copolymerization of the alkylene oxide and carbon dioxide at lower temperatures and pressures (lower pressure of carbon dioxide). Lower temperatures and pressures can reduce equipment costs. The method of the present invention further enables maintaining high reaction rates and, therefore, shorter overall times to form the PEC polyol.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a ¹H NMR spectrum printout for the PEC polyol formed in Example 2;

FIG. 1B is a ¹H NMR spectrum printout for the PEC polyol formed in Example 4;

FIG. 1C is a ¹H NMR spectrum printout for the PEC polyol formed in Example 9; and

FIG. 2 is an IR spectroscopy printout associated with a representative method of forming a PEC polyol.

### DETAILED DESCRIPTION OF PREFERRED EMBODIMENTS

A method of forming a polyethercarbonate (PEC) polyol is disclosed. Preferably, the PEC polyol formed according to the present invention is utilized, in conjunction with a suitable cross-linking agent, such as an isocyanate, to produce foamed and non-foamed, i.e., elastomeric, polyurethane polymers. The method of the present invention preferably forms the PEC polyol according to a variety of reaction parameters. These various reaction parameters and the strategic modification of the reaction parameters are described additionally below in the context of the preferred embodiment of the invention.

The method provides a catalyst that comprises a multimetal cyanide compound. The multimetal cyanide compound is also described additionally below. Generally, the PEC polyol is the polymerization reaction product of an H-functional initiator, an alkylene oxide, and carbon dioxide (collectively “the reactants”). The method reacts the reactants, preferably under a positive pressure, in the presence of the multimetal cyanide compound in a reactor to form the PEC polyol. Although not required, a semi-batch reactor, such as an industrial autoclave, is preferred. It is known that, during the reaction, first and second reaction phases are present in the reactor. The first reaction phase is liquid and includes the H-functional initiator, dissolved alkylene oxide and carbon dioxide, the multimetal cyanide compound, and the PEC polyol that is forming. The second reaction phase includes gaseous or supercritical alkylene oxide and carbon dioxide.

As a result of the reactants, the PEC polyol includes a polyethercarbonate segment, i.e., linkage, and a polycarbonate segment and/or a polyether segment. That is, the PEC polyol may include the polyethercarbonate segment and only the polycarbonate segment, the polyethercarbonate segment and only the polyether segment, or the polyethercarbonate segment and both the polycarbonate and polyether segments. These segments, their type and relative amounts, are part of a composition, i.e., microstructure, of the PEC polyol formed by the method of the present invention. As such, this PEC polyol is essentially a copolymer of alkylene oxide and carbon dioxide having a defined polyethercarbonate, polycarbonate, and polyether microstructure.

The PEC polyol, more specifically, comprises the general formula [A]ₐ[B]_{b}[C]_{c}. In this general formula:

A is a polyethercarbonate segment, B is a polycarbonate segment, and C is a polyether segment wherein each of A, B, and C are defined by the presence of CH₃ group resonances of alkylene oxide-based ether chain units at separate peaks in a ¹H NMR spectrum of the polyethercarbonate polyol;

a is a value from 1-98, b is a value from 0-60, and c is a value from 0-98 so long as b and c are both not equal to 0; and

the values for each of a, b, and c are in area % based on the presence of the CH₃ group resonances in the ¹H NMR spectrum and on the integration of the area under the respective peaks that are present in the ¹H NMR spectrum.

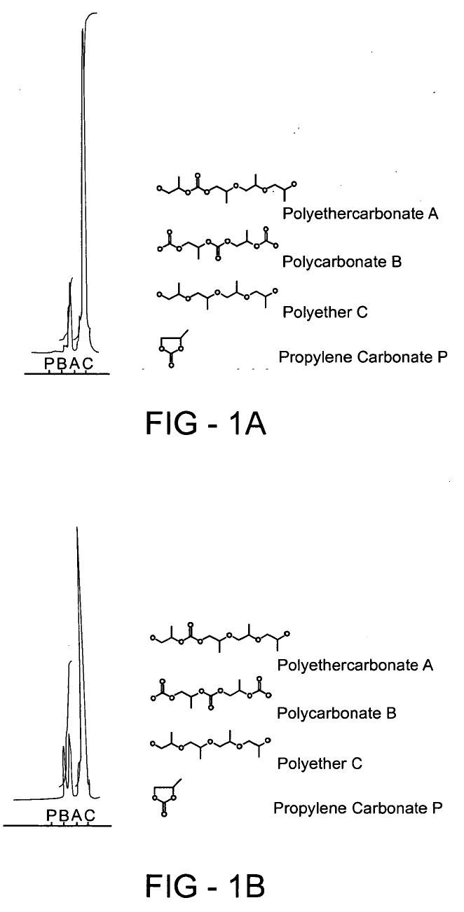

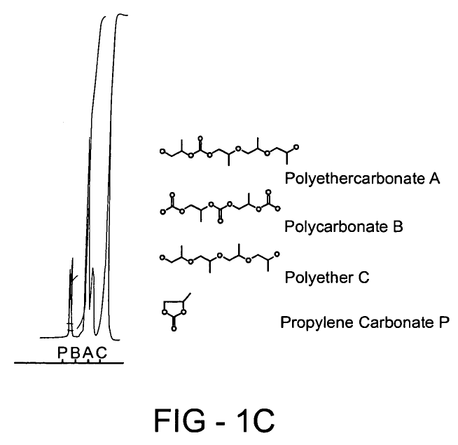

Using ¹H NMR spectroscopy, with a standard such as a tetramethylsilane (TMS) standard, to obtain the ¹H NMR spectrum for the final PEC polyol including the various peaks enables a determination of the ratio of the polyethercarbonate, polycarbonate, and polyether segments in the final PEC polyol. Referring generally to the various ¹H NMR spectrum printouts disclosed in FIGS. 1A-1C, the various CH₃ group resonances of alkylene oxide-based (in this case propylene oxide-based) ether chain units are identified as distinct peaks and can be quantified via standard integration. The ¹H NMR spectrum printout of FIG. 1A is a printout from the PEC polyol formed in Example 2 below, the ¹H NMR spectrum printout of FIG. 1B is a printout from the PEC polyol formed in Example 4 below, and the ¹H NMR spectrum printout of FIG. 1C is a printout from the PEC polyol formed in Example 9 below. In these ¹H NMR spectrum printouts, although the TMS standard does not appear, it is a baseline that measures on the far right. The peak chemical shifts ‘downfield’ from the TMS standard (i.e., to the left of the TMS standard) are represented on the X-axis and the relative intensity of the various CH₃ group resonances is represented on the Y-axis. The polyethercarbonate-CH₃ group resonances (A), the polycarbonate-CH₃ group resonances (B), and the polyether-CH₃ group resonances (C) are located at 0.9 ppm-1.3 ppm downfield from, or to the left of, TMS. The polyether-CH₃ group resonance (C) is most upfield (i.e., closest to TMS and furthest to the right as compared to the polyethercarbonate-CH₃ and polycarbonate-CH₃ group resonances and having the smallest peak chemical shift from TMS of 0.9 ppm-1.1 ppm). The polyether-CH₃ group resonance (C) is then followed downfield, i.e., to the left, by the polyethercarbonate-CH₃ group resonances (A) and then by the polycarbonate-CH₃ group resonances (B) (which are, comparatively, furthest to the left). The varying CH₃ group resonances due to:

A polyethercarbonate-CH₃ groups;

B polycarbonate-CH₃ groups;

C polyether-CH₃ groups; and

P propylene carbonate-CH₃ groups

disclosed in these printouts allow for the qualitative identification and quantitative determination of the composition, i.e., microstructure, of the final PEC polyols. The PEC polyol composition can also be described using the relative ratio of these ¹H NMR CH₃ group resonances. For the purposes of the discussion above and also in Examples 1-11 below, the peak associated with the undesirable cyclic byproduct, propylene carbonate (P), has been ignored but is generally to the left of the polycarbonate-CH₃ group resonances (B).

The polyethercarbonate (A), polycarbonate (B), and polyether (C) segments are more specifically defined by their sequence of carbonate and ether units as follows. The polyethercarbonate segments are defined by their polyethercarbonate-CH₃ groups being located in the polymer chain between 1 carbonate unit and 1 alkylene ether unit as generally indicated by [—CO₂-AO(CH₃)-AO—]. The polycarbonate segments are defined by their polycarbonate-CH₃ groups being located in the polymer chain between 2 carbonate units as generally indicated by [—CO₂-AO(CH₃)—CO₂—]. The polyether segments are defined by their polyether-CH₃ groups being located in the polymer chain between 2 alkylene ether units as generally indicated by [-AO-AO(CH₃)-AO —]. Finally, in the various ¹H NMR spectrum printouts disclosed immediately above, the undesirable cyclic byproduct segment, an alkylene carbonate such as propylene carbonate (P), is defined by alkylene carbonate-CH₃ groups attached to a 5-membered alkylene carbonate. As one example, when some content of propylene oxide is utilized as the alkylene oxide, the analytical technique “looks for” [—CO₂—PO(CH₃)-AO—] for the polyethercarbonate segments, [—CO₂—PO(CH₃)—CO₂—] for the polycarbonate segments, and [-AO—PO(CH₃)-AO—] for the polyether segments.

The polyethercarbonate segments more specifically include non-regular, i.e., random, alternating copolymers of alkylene oxide monomer and carbon dioxide monomer and comprises the general formula [—CO₂-(AO)ₓ—CO₂-(AO)_{y}—] wherein CO₂ is a carbon dioxide monomer and AO is an alkylene oxide monomer, x is a value >1 and y is a value >1, and a molar ratio of AO:CO₂ is >1. That is, the molar ratio of the alkylene oxide monomer:the carbon dioxide monomer is greater than 1. Relative to the polyethercarbonate segment, the method also includes the step of selectively controlling the value of x, the value of y, or the molar ratio of AO:CO₂. For descriptive purposes only, a sample polyethercarbonate segment is disclosed below.

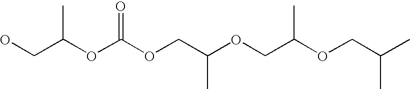

The polycarbonate segments more specifically include regular, repeating copolymers of alkylene oxide monomer and carbon dioxide monomer and is of the general formula [—CO₂-AO—CO₂-AO—]. For descriptive purposes only, a sample polycarbonate segment is disclosed below.

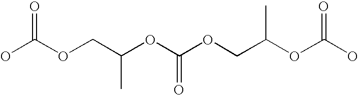

The polyether segments more specifically include all alkylene oxide monomer and comprises the general formula [-AO-(AO)_{z}-AO—] wherein AO is the alkylene oxide monomer, and z is a value >0. It is to be understood that the polyether segment may be defined as part of the polyethercarbonate segments. Relative to the polyether segment, the method also includes the step of selectively controlling the value of z. For descriptive purposes only, a sample polyether segment is disclosed below.

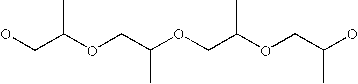

Relative to the other segments of the PEC polyol, the polyethercarbonate segment is semi-rigid, the polycarbonate segment is rigid, and the polyether segment is flexible. The rigidity and flexibility of these segments and, therefore, the rigidity and flexibility of the overall PEC polyol are taken into account when targeting desired physical properties for the polyurethane polymers. More specifically, the type of segment that is desired is selected and designed into the PEC polyol. Further, the ratio of one type of segment to another type of segment is also selected and designed into the PEC polyol.

The method of the present invention also includes the step of selectively controlling the value of a, b, or c, i.e., the relative amounts for the polyethercarbonate segment, the polycarbonate segment, and the polyether segment. Because these values are selectively controlled, the amounts for each of the polyethercarbonate segment, the polycarbonate segment, and the polyether segment in the PEC polyol can vary. Preferably, the value of a is from 5-80, the value of b is from 1-40, and the value of c is from 20-95. More preferably, the value of a is from 5-35, the value of b is from 5-18, and the value of c is from 65-95.

In the preferred embodiment, the present invention accomplishes this selective control by modifying at least one of the reaction parameters. As will be realized from the description below, there are a wide variety of reaction parameters including, but not limited to, temperature of the reactor, pressure of the reactor, concentration of the multimetal cyanide compound, concentration of the H-functional initiator, concentration of the alkylene oxide, concentration of the carbon dioxide, a length of time that the alkylene oxide is fed into the reactor, a rate that the alkylene oxide is fed into the reactor, i.e., the amount of alkylene oxide that is fed into the reactor over the length of time, at what point in time during the method the reactor dioxide pressurized with carbon dioxide, availability of carbon dioxide, choice of H-functional initiator, composition of the catalyst, amount of water in the reactor, and a ratio of alkylene oxide:carbon dioxide.

Steps to modify the reaction parameters include, but are not limited to, modifying and/or ramping up or down the temperature of the reactor, modifying and/or ramping up or down the pressure of the reactor, modifying the concentration of the multimetal cyanide compound, modifying the concentration of the reactants, extending the length of time that the alkylene oxide is fed into the reactor, ramping up or down the rate that the alkylene oxide is fed into the reactor, feeding the alkylene oxide into the reactor in such a manner that a concentration of the alkylene oxide in the liquid reaction phase of from 4-20%, preferably from 8-12%, is maintained, selectively restricting an availability of the carbon dioxide for at least a portion of the length of time that the alkylene oxide is fed into the reactor, ramping up or down the temperature of the reactor during the feeding of the alkylene oxide into the reactor, ramping up or down the temperature of the reactor during the course of the alkylene oxide reaction, selecting an H-functional initiator with a specific number-average and/or weight average molecular weight, or a specific polydispersity, or a specific functionality, agitating the reactor during the reacting of the reactants, providing a sterically-hindered chain transfer agent, activating the catalyst, and restricting an amount of water in the reactor. As alluded to above, the method of the present invention synergistically controls specific reaction parameters and modifies at least one of the reaction parameters to selectively control the amount of the segments in the forming PEC polyol. As used throughout the subject description, the terminology ramping, ramp, or ramped accounts for increasing (ramping up) the reaction parameter and also for decreasing (ramping down) the reaction parameter. Preferably the reaction parameters, when ramped, are ramped at a constant rate.

As a result of the modification of at least one of the reaction parameters, the carbon dioxide is more effectively incorporated into the PEC polyol because the carbon dioxide is not merely randomly incorporated into the PEC polyol. Instead, as will be realized in view of the description and Examples below, the carbon dioxide is strategically incorporated into the PEC polyol to selectively establish or to selectively not establish polyethercarbonate, polycarbonate, and polyether segments.

As alluded to above, a temperature of the reactor can be modified. If the temperature is modified, it is preferred that the temperature is modified between 40 and 180° C., more preferably between 50 and 150° C., and most preferably between 65 and 135° C. In addition to modifying the temperature of the reactor, a pressure of the reactor can be modified. The pressure of the reactor can be modified independent of, or in conjunction with, modification of the temperature of the reactor. If the pressure is modified, it is preferred that the pressure is modified between 10 and 3000 psi, more preferably between 90 and 1000 psi, and most preferably between 100 and 700 psi.

As described above, further reaction parameters that can be modified include concentrations of the various reactants and the catalyst. More specifically, relative to the reactants, a concentration of the H-functional initiator can be modified to selectively control the ratio and type of segments of the PEC polyol, a concentration of the alkylene oxide can be modified to selectively control the ratio and type of segments of the PEC polyol, and a concentration of the carbon dioxide can be modified to selectively control the ratio and type of segments of the PEC polyol. Furthermore, a concentration of the multimetal cyanide compound can be modified to selectively control the ratio and type of segments of the PEC polyol. These concentrations can be modified independently or more than one concentration can be modified. Further, it is to be understood that there are many different mechanisms for modifying the concentration. Non-limiting examples include modifying an amount of the reactants and/or the catalyst, and modifying a rate that the reactants and/or catalyst are introduced.

The concentrations above generally refer to the concentration of the particular reactant in the liquid phase in the reactor. The ratio of alkylene oxide concentration in the liquid phase:the carbon dioxide concentration in the liquid phase is, in combination with the temperature of the reactor, the preferred reaction parameter that is used to influence incorporation of the carbon dioxide into the PEC polyol.

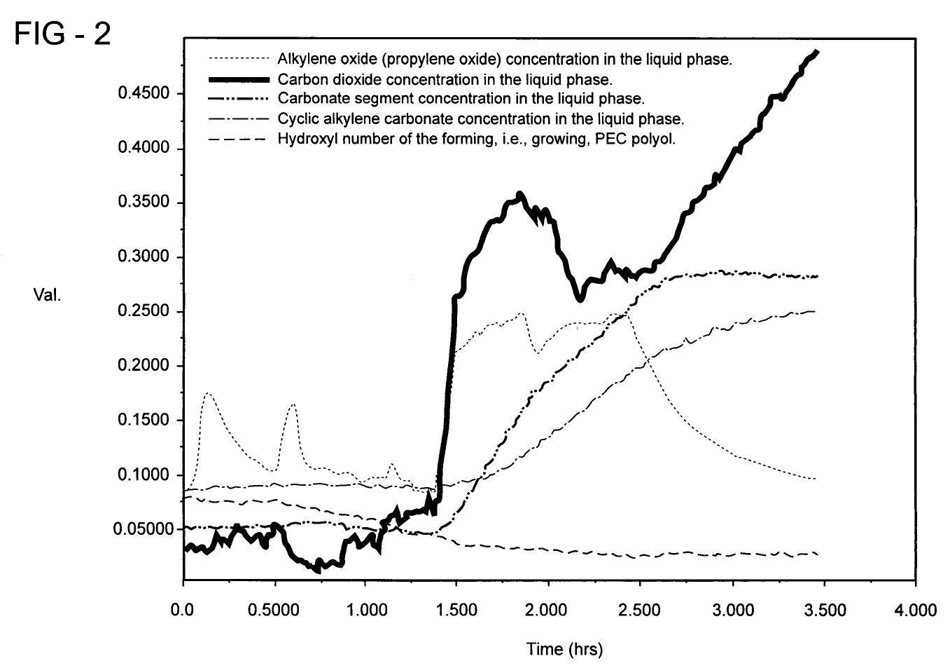

In addition to ¹H NMR spectroscopy, on-line IR spectroscopy (using a REACT IR equipped with sentinel probe technology available from Mettler-Toledo) permits measuring of the key reaction parameter relating to concentrations of the reactants. Generally, the IR spectroscopy illustrates the relative concentrations over time and the overall carbonate content in the PEC polyol in the liquid phase, as distinguished from the cyclic carbonate content. Specifically, the IR spectroscopy printout in FIG. 2 illustrates alkylene oxide (specifically propylene oxide) concentration in the liquid phase, carbon dioxide concentration in the liquid phase, carbonate segment concentration in the liquid phase (from both polyethercarbonate and polycarbonate), cyclic alkylene carbonate concentration in the liquid phase, and the relative hydroxyl number of the forming, i.e., growing, PEC polyol. This relative hydroxyl number is not the actual hydroxyl number of the PEC polyol.

In the IR spectroscopy printout of FIG. 2, the X-axis is indicative of time (in hours). On the other hand, the value associated with the Y-axis does not have a meaning as units. Instead, the Y-axis is only utilized to interpret relative concentrations and concentration (or change in hydroxyl number) over time.

The method includes charging the reactor with the H-functional initiator and the multimetal cyanide compound. In the preferred embodiment, the reaction step includes feeding the alkylene oxide into the reactor over a length of time. Preferably, this length of time is at least 2 hours. As such, it is preferred that the alkylene oxide is fed into the reactor over at least 2 hours. The length of time that the alkylene oxide is added into the reactor can be extended. Extending the length of time influences the concentration of the alkylene oxide relative to the other reactants and the multimetal cyanide compound. Furthermore, the rate that the alkylene oxide is fed into the reactor can be ramped up or down over the length of time that the alkylene oxide is fed into the reactor. As alluded to above, the temperature of the reactor is a key reaction parameter utilized in the present invention. Most preferably, the temperature of the reactor is ramped up or down during the feeding of the alkylene oxide into the reactor.

The reaction step also more specifically includes pressurizing the reactor with carbon dioxide. Carbon dioxide pressure influences the amount of carbon dioxide incorporation into the PEC polyol. The reactor can be pressurized with carbon dioxide after the feeding of the alkylene oxide into the reactor. Alternatively, the reactor can be pressurized with carbon dioxide during the feeding of the alkylene oxide into the reactor, i.e., as the alkylene oxide is being fed into the reactor. Additionally, the time at which the reactor is pressurized with carbon dioxide is an important reaction parameter that can be modified. That is, the availability of the carbon dioxide can be selectively restricted for at least a portion of the length of time that the alkylene oxide is fed into the reactor.

Also, the choice of the H-functional initiator is a reaction parameter that influences the ability to selectively control the composition of the PEC polyol. More specifically, the specific functionality of the H-functional initiator, the specific number-average molecular weight, the specific weight average molecular weight, and the specific polydispersity (Mw/Mn) of the H-functional initiator, all can influence the ability to selectively control the composition. The functionality of the H-functional initiator is preferably of from 1 to 8, more preferably from 1 to 4. The number-average molecular weight of the H-functional initiator is preferably of from 92 to 2000, more preferably from 176 to 1200, and most preferably from 600 to 940, Daltons. The polydispersity of the H-functional initiator is preferably from 1.0 to 5.0, more preferably from 1.0 to 2.0, and most preferably from 1.0 to 1.2. In view of the preceding description, it is apparent that the particular type of the H-functional initiator that is selected can vary. Various H-functional initiators are described below.

A further reaction parameter that can be modified to control the ratio of the segments in the final PEC polyol involves the sterically-hindered chain transfer agent, and whether the sterically-hindered chain transfer agent is provided, along with the reactants, or not. As is known in the art, sterically-hindered chain transfer agents are typically included to protonate the PEC polyol that is forming, i.e., the growing PEC polyol. More specifically, it is possible to include the sterically-hindered chain transfer agent and react the H-functional initiator, the alkylene oxide, and carbon dioxide in the presence of both the sterically-hindered chain transfer agent and the multimetal cyanide compound. If included, the sterically-hindered chain transfer agent is preferably selected from the group of a sterically-hindered alcohol, a sterically-hindered phenol, a sterically-hindered benzoic acid, a sterically-hindered thiol, and combinations thereof.

Furthermore, it is known that catalysts including multimetal cyanide compounds can be deactivated by water and/or carbon dioxide and/or activity-reducing, catalyst site blockers, such as metal hydroxides and amines. These components can poison the catalyst. Thus, the present invention contemplates that a further reaction parameter that can be modified to control the amount of the segments in the final PEC polyol involves the particular catalyst and modifying the reaction parameter involves activating the catalyst. Activating the catalyst includes removing free water and catalyst bound water from the reactor. The catalyst bound water is removed from a surface of the catalyst. Activating the catalyst also includes removing the activity-reducing, catalyst site blockers from the surface of the catalyst.

Once the catalyst is appropriately activated, it is preferred to restrict an amount of water in the reactor to maintain the activity of the catalyst throughout the course of the reacting step. In large part, the restriction of the amount of water is accomplished by controlling the inherent water content of the incoming reactants that are being utilized. Once the catalyst is appropriately activated, it is also preferred to prevent reformation of the activity-reducing, catalyst site blockers throughout the course of the reacting step. Generally, this is accomplished by controlling the amount of water in the reactor. However, particular attention should also be paid to restrict the introduction of other activity-reducing, catalyst side blockers into the reactor.

More specifically, activating the catalyst should be carried out in a multi-step process. The first step involves removal of free water under vacuum of less than 10 mmHg, preferably less than 1 mmHg, and more preferably less than 0.1 mmHg and under temperatures of 100° C., preferably 120° C., and more preferably 140° C. The second step involves chemical removal of the catalyst bound water. Chemical removal can be achieved through the addition of a species that is reactive with water, such as an alkylene oxide. The species may also be referred to as a water removing reagent. Because it has been demonstrated, that the simple addition of such a species, such as an alkylene oxide, followed by waiting for an induction period the end of which is indicated by the beginning of alkylene oxide polymerization, does not quantitatively remove water and the activity-reducing, catalyst site blockers from the surface of the catalyst, it is preferred that the species is added in multiple steps. Multiple additions of the species increases catalyst activity.

As set forth above, once the catalyst is appropriately activated, the amount of water in the reactor is restricted, preferably by controlling the inherent water content of the incoming reactants that are being utilized. As such, a preferred water content for each of the reactants is <500 ppm, more preferably <100 ppm, and most preferably <10 ppm. Furthermore, total water content in the reaction mixture should be maintained below <500 ppm, more preferably <100 ppm, and most preferably <10 ppm to prevent the reformation of the activity-reducing, catalyst site blockers throughout the course of the reacting step.

As described above, the catalyst includes the multimetal cyanide compound. In the present invention, a unique catalyst, specifically a unique multimetal cyanide compound, is utilized. In addition to the multimetal cyanide compound, it is preferred that the catalyst further comprises at least one of: an organic complexing agent; water; a polyether; and a surface-active substance. It is more preferred that the catalyst include all of these additional components, specifically the organic complexing agent, water, the polyether, and the surface-active substance. As a result, the catalyst is preferably used in the form of a suspension and the multimetal cyanide compound preferably has a crystalline structure, rather than the catalyst being used in a powder form and being in an amorphous structure. The suspension and the crystalline structure provide high catalytic activity.

Furthermore, the multimetal cyanide compound preferably has a content of platelet-shaped (i.e., platelet-like morphology) particles of at least 30% by weight, based on a weight of the multimetal cyanide compound. For the purposes of the present invention, platelet-shaped particles are particles whose thickness is one third, preferably one fifth, more preferably one tenth, of their length and width. The more preferred catalyst according to the present invention contains more than 50% by weight of such platelet-shaped particles, most preferably more than 70% by weight. Concentrations that are employed for the catalysts are typically less than 1% by weight, preferably less than 0.5% by weight, particularly preferably less than 1,000 ppm, very particularly preferably less than 500 ppm, and especially preferably less than 100 ppm, based on the total mass of the PEC polyol.

A wide variety of catalysts which include the multimetal cyanide compound are possible for use in the context of the present invention. Examples of such catalysts include, but are not limited to, the catalysts disclosed and taught in U.S. Pat. Nos. 6,303,833 and 6,762,278, the disclosures of which are hereby incorporated by reference in their entirety.

Generally, the H-functional initiators are mono-alcohols and poly-alcohols. More specifically, suitable H-functional initiators include, but are not limited to, alkanols such as butanol, diols such as butane diol, glycols such as dipropylene glycol, glycol monoalkyl ethers, aromatic hydroxy compounds, glycerine, trimethylol propane, and pentaerythritol. It is possible for the H-functional initiator to include one or more alkylene oxide groups for the catalyst to function more efficiently. In such a case, the H-functional initiator is first reacted with at least one alkylene oxide to form an oligomer prior to it use to form the PEC polyol. Examples include glycerine having from 1 to 6 propylene oxides attached to it, propylene glycol having 1 to 6 propylene oxides, trimethyl propane with 1 to 6 propylene oxides, dipropylene glycol with one or more alkylene oxides attached, sucrose with one or more alkylene oxides attached, sorbitol with one or more alkylene oxides attached, and blends of these oligomers. As would be understood by one of ordinary skill in the art, the oligomer can be reacted with either the same alkylene oxide used during its formation or with another alkylene oxide in the PEC polyol formation reaction.

Suitable alkylene oxides include, but are not limited to, compounds having at least one alkylene oxide group, such as example ethylene oxide, propylene oxide (1,2-epoxypropane), 1,2-methyl-2-methylpropane, butylene oxide(1,4-epoxybutane), 1,2-epoxybutane, 2,3-epoxybutane, 1,2-methyl-3-methylbutane, 1,2-epoxypentane, 1,2-methyl-3-methylpentane, 1,2-epoxyhexane, 1,2-epoxyheptane, 1,2-epoxyoctane, 1,2-epoxynonane, 1,2-epoxydecane, 1,2-epoxyundecane, 1,2-epoxydodecane, styrene oxide, 1,2-epoxycyclopentane, 1,2-epoxycyclohexane, (2,3-epoxypropyl)-benzene, vinyloxirane, 3-phenoxy-1,2-epoxypropane, 2,3-epoxy (methyl ether), 2,3-epoxy (ethyl ether), 2,3-epoxy (isopropyl ether),2,3-epoxy-1-propanol, 3,4-epoxybutyl stearate, 4,5-epoxypentyl acetate, 2,3-epoxy propyl methacrylate, 2,3-epoxypropyl acrylate, glycidol butyrate, methyl glycidate, ethyl 2,3-epoxybutanoate, 4-(trimethylsilyl)butane 1,2-epoxide, 4-(trimethylsilyl)butane 1,2-epoxide, 3-(perfluoromethyl)propene oxide, 3-perfluoromethyl)propene oxide, 3-(perfluorobutyl)propene oxide, and also any mixtures of the abovementioned compounds. The most preferred alkylene oxides include ethylene oxide, propylene oxide, and butylene oxide.

The present invention is very useful for the formation, or synthesis, of PEC polyols having functionalities of from 1 to 8, preferably from 1 to 4, and weight average molecular weights of from 200 to 25,000, more preferably from 900 to 20,000, Daltons. The desired CO₃ content of the PEC polyol, as measured by IR spectroscopy, is preferably from 1 to 30%, more preferably from 2 to 20%, and most preferably from 5 to 15%, based on weight % of CO₃ of the PEC polyol. The PEC polyols can be prepared either batchwise, semi-continuously, or fully continuously.

As initially described above, the PEC polyols formed according to the present invention are combined with the cross-linking agent to produce foamed and non-foamed polyurethane polymers. If the cross-linking agent is an isocyanate, the isocyanates that may be used preferably include isomers and derivatives of toluene diisocyanate (TDI) and diphenylmethane diisocyanate (MDI). The reaction between the hydroxyl groups and the isocyanate groups may be catalyzed by tertiary amine catalysts and/or organic tin compounds such as stannous octoate and dibutyltin dilaureate. Also, to obtain a foamed polyurethane polymer, blowing agents may be employed. In addition, stabilizers and flame retardants may be added.

It is to be understood that all of the preceding chemical representations are merely two-dimensional chemical representations and that the structure of these chemical representations may be other than as indicated.

The following examples illustrating the formation of the catalyst including the multimetal cyanide compound and the formation of the PEC polyol, as presented herein, are intended to illustrate and not limit the present invention.

### EXAMPLES

A catalyst including the multimetal cyanide compound was prepared as described below.

Preparation of Hexacyanocobalfic Acid

An amount of 7 liters of strong acid ion exchanger in the sodium form (Amberlite® 252 Na, Rohm & Haas) was introduced into an ion exchange column (length: 1 m, volume: 7.7 l). The ion exchanger was subsequently converted into the H form by passing 10% strength hydrochloric acid through the ion exchange column for 9 hours at a rate of 2 bed volumes per hour, until the sodium content of the discharged solution was less than 1 ppm. The ion exchanger was subsequently washed with water until neutral. The regenerated ion exchanger was then used to prepare a hexacyanocobaltic acid which was essentially free of alkali metal. For this purpose, a 0.24 molar solution of potassium hexacyanocobaltate in water was passed through the ion exchanger at a rate of 1 bed volume per hour. After 2.5 bed volumes, the feed was changed from potassium hexacyanocobaltate solution to water. The 2.5 bed volumes obtained had an average hexacyanocobaltic acid content of 4.5% by weight and alkali metal contents of less than 1 ppm. The hexacyanocobaltic acid solutions used for the further examples were diluted appropriately with water.

Preparation of a Catalyst Suspension Including the Multimetal Cyanide Compound

An amount of 479.3 g of an aqueous zinc acetate solution (13.8 g of zinc acetate dihydrate and 2.2 g of polyether Pluronic® PE 6200 (BASF Aktiengesellschaft) dissolved in 150 g of water) was heated to 50° C. While stirring (screw stirrer, stirring energy input: 1 W/l), 558 g of an aqueous hexacyanocobaltic acid solution (cobalt content: 9 g/l, 1.5% by weight of Pluronic® PE 6200 (BASF Aktiengesellschaft), based on the hexacyanocobaltic acid solution) were then metered in over a period of 20 minutes. After all the hexacyanocobaltic acid solution had been metered in, the mixture was stirred for a further 5 minutes at 50° C. The temperature was subsequently reduced to 40° C. over a period of one hour. The precipitated solid was separated from the liquid by means of a pressure filter and washed with water. The moist filter cake was subsequently dispersed in the amount of liquid required to give a 5% strength by weight multimetal cyanide suspension.

Preparation of PEC Polyols

The PEC polyols of the present invention were prepared using the general procedures (Small Scale and Large Scale) as described below.

General Small Scale Preparation of PEC Polyols

A clean and dry 300 ml autoclave, equipped with an agitator, external heating, internal cooling via a cooling coil, a propylene oxide feed line, a carbon dioxide gas feed line, a temperature sensor and a pressure sensor, was charged with 70 g of a purified H-functional initiator and the multimetal cyanide compound containing catalyst. The H-functional initiator used in these experiments was an adduct of glycerine and propylene oxide monomer with a number average molecular weight of 730, a water content <0.03% and a residual catalyst content <5 ppm. The H-functional initiator-catalyst mixture was heated to 130° C. under vacuum (<1 mm Hg) for 2 hours to remove any residual moisture. The vacuum system was disconnected and the reactor pressurized to 0 psi using Argon gas. Then 5 g of propylene oxide was added and the pressure increase in the reactor was monitored. Within 15-30 minutes the reactor pressure declines back to 0 psi, indicating that the multimetal cyanide compound containing catalyst has been activated and is now active. Then 170 g propylene oxide (PO) monomer is added at 130° C. at a constant rate of 1 g /min. After 5 minutes of the PO feed, the reactor was pressurized with CO₂ gas (Air Products, research grade) for the duration of the PO feed. Following the completion of the PO addition step, unreacted monomer was left to react out at 130° C. The reactor was then vented and cooled and the product collected. The peak molecular weight and the weight average molecular weight were determined by gel permeation chromatography. The viscosity was measured using a Brookfield DV-III rheometer. The carbonate content of the PEC polyol was determined by IR (peak at 1745 cm-1) and calculated as weight% CO₃ in the PEC polyol. Propylene carbonate formed as a by-product was not removed.

General Large Scale Preparation of PEC Polyols

In a series of experiments, the PEC polyol formation reaction was scaled up to a larger two gallon autoclave using a multimetal cyanide compound prepared according to the present invention. The general procedure was as described below. A clean and dry 2 gallon autoclave, equipped with an agitator, external heating, internal cooling via a cooling coil, a PO feed line, a gas feed line, a temperature sensor and a pressure sensor, was charged with a purified H-functional initiator, which as a polyol and an adduct of glycerine and propylene oxide monomer with a number average molecular weight of 730, a water content <0.03% and a residual catalyst content <5 ppm, and the multimetal cyanide compound containing catalyst was prepared as described above. The multimetal cyanide compound containing catalyst was dried and stored and handled under Argon. The H-functional initiator-catalyst mixture is heated to 130° C. under vacuum (<1 mm Hg) for 2 hours to remove any residual moisture. Water content in the initiator mixture after this initial drying step was <0.01%. The vacuum system is disconnected and the reactor pressurized to 0 psi using Argon gas. Then 200 g of propylene oxide (dried and distilled from CaH2, water content <10 ppm%) is added and the pressure increase in the reactor is monitored. Within 15-30 minutes the reactor pressure declines back to 0 psi, indicating that the multimetal cyanide compound containing catalyst is active. An amount of 2,500 g of PO monomer is then added at 130° C. at a constant rate over 3 hours. At 10 minutes after commencement of the PO feed, the reactor is pressurized with CO₂ gas (Air Products, research grade, dried over molecular sieves, water content <10 ppm %) for the duration of the PO feed and the PO reaction. Following the completion of the PO addition step, unreacted monomer is left to react out at 130° C. The reactor is then vented and cooled and the product collected. The peak molecular weight and the weight average molecular weight were determined by gel permeation chromatography. The viscosity was measured using a Brookfield DV-III rheometer. The carbonate content of the PEC polyol was determined by IR (peak at 1745 cm-1) and calculated as weight % CO₃ in the PEC polyol. The product was filtered using 3% diatomaceous earth filter aid. The propylene carbonate formed as a by-product was removed by distillation under vacuum when required.

### Small Scale PEC Polyol Example 1

Referring to Table 1 below, PEC Polyol Example 1 was prepared according to the present invention as follows. An amount of 1,000 g of the H-functional initiator and 20 g of a suspension of the multimetal cyanide containing catalyst, described above, were used. The reaction temperature was 130° C. and the reactor was pressurized with CO₂ to 500 psi Propylene oxide monomer (2700 g) was added during 3 hours in a manner that maintained the concentration of the propylene oxide monomer in the liquid reaction phase at 10-11 weight % based on the total weight of the liquid reaction phase. The yield of the reaction product obtained was 3,859 g. Its peak molecular weight was 2,11 1 and its weight average molecular weight was 2,990. Its polydispersity Mw/Mn was 1.26. IR spectroscopy indicated a total carbonate content of the PEC polyol of 5.8 weight % CO₃. ¹H NMR revealed a ratio of polyethercarbonate segments (A):polycarbonate segments (B):and polyether segments (C) of 9:1:90. As indicated above, this ratio for the (A), (B), and (C) segments and the ratios that follow indicate relative amounts between the (A), (B), and (C) segments. As such, they ratios have been normalized to equal 100 such that the relative amounts are representative of approximate percentages of the (A), (B), and (C) segments.

### Small Scale PEC Polyol Example 2

PEC polyol Example 2 was prepared according to the present invention as follows. An amount of 900 g of the H-functional initiator and 20 g of a suspension of the multimetal cyanide containing catalyst, described above, were used. The reaction the temperature was 130° C. and the reactor was pressurized with CO₂ to 600 psi. Propylene oxide monomer (2700 g) was added during 6 hours in a manner that maintained the concentration of the propylene oxide monomer in the liquid reaction phase at 7-8 weight % based on the total weight of the liquid reaction phase. The yield of the reaction product obtained was 4,007 g. Its peak molecular weight was 2,156 and its weight average molecular weight was 3,209. Its polydispersity Mw/Mn was 1.23. IR spectroscopy indicated a total carbonate content of the PEC polyol of 7.0 weight % CO₃. ¹H NMR revealed a ratio of polyethercarbonate segments (A):polycarbonate segments (B):and polyether segments (C) of 13:3:84.

Examples 1 and 2 demonstrate that, by selectively controlling and/or modifying at least one reaction parameter (increasing the length of the PO feed time and maintaining a reduced PO concentration in the liquid reaction phase), it is possible to form a PEC polyol with triple the content of polycarbonate segments, while essentially maintaining the overall carbonate content.

### Small Scale PEC Polyol Example 3

PEC polyol Example 3 was prepared according to the present invention as follows. An amount of 900 g of the H-functional initiator, which is an adduct of propylene glycol and propylene oxide monomer with a number average molecular weight of 770, a water content <0.03% and a residual catalyst content <5 ppm, and 20 g of a suspension of the multimetal cyanide compound containing catalyst, described above, were used. The reaction temperature was 110° C. and the reactor was pressurized with CO₂ to 700 psi. The propylene oxide monomer (2700 g) was added during 4 hours in a manner that maintained the concentration of the propylene oxide monomer in the liquid reaction phase at 8-10 weight % based on the total weight of the liquid reaction phase. The yield of the reaction product obtained was 4,011 g. Its peak molecular weight was 2,402 and its weight average molecular weight was 4,849. Its polydispersity Mw/Mn was 1.63. IR spectroscopy indicated a total carbonate content of the PEC polyol of 12.1 weight % CO₃. ¹H NMR revealed a ratio of polyethercarbonate segments (A):polycarbonate segments (B):and polyether segments (C) of 19:8:73.

### Small Scale PEC Polyol Example 4

PEC Polyol Example 4 was prepared according to the present invention as follows. An amount of 900 g of the purified H-functional initiator, which is an adduct of propylene glycol and propylene oxide monomer with a number average molecular weight of 770, a water content <0.03% and a residual catalyst content <5 ppm, and 14 g of a suspension of the multimetal cyanide compound containing catalyst, described above, were used. The reaction temperature was 110° C. and the reactor was pressurized with CO₂ to 2470 psi until the concentration of CO₂ in the liquid reaction phase reached a steady state. The propylene oxide monomer (2700 g) was added during 4 hours in a manner that maintained the concentration of the propylene oxide monomer in the liquid reaction phase at 8-10 weight % based on the total weight of the liquid reaction phase. The yield of the reaction product obtained was 4,563 g. Its peak molecular weight was 1,507 and its weight average molecular weight was 12,095. Its polydispersity Mw/Mn was 4.29. IR spectroscopy indicated a total carbonate content of the PEC polyol of 18.0 weight % CO₃. ¹H NMR revealed a ratio of polyethercarbonate segments (A):polycarbonate segments (B):and polyether segments (C) of 11:8:81.

Examples 3 and 4 demonstrate that, by selectively controlling and/or modifying at least one reaction parameter (increasing the carbon dioxide concentration in the liquid phase, permitting the concentration of CO₂ to reach a steady state, while at the same time decreasing the catalyst concentration in the reaction mixture), it is possible to form a PEC polyol having increased overall carbonate content by 50% (from 12% to 18%) while decreasing the content of polyethercarbonate segments from 19% to 11%.

### Small Scale PEC Polyol Example 5

PEC Polyol Example 5 was prepared according to the present invention as follows. An amount of 900 g of the purified H-functional initiator, which is an adduct of propylene glycol and propylene oxide monomer with a number average molecular weight of 770, a water content <0.03% and a residual catalyst content <5 ppm, and 20 g of a suspension of the multimetal cyanide compound containing catalyst, described above, were used. The reaction temperature was 130° C. and the reactor was pressurized with CO₂ to 700 psi. The propylene oxide monomer (2700 g) was added during 4 hours in a manner that maintained the concentration of the propylene oxide monomer in the liquid reaction phase at 6-8 weight % based on the total weight of the liquid reaction phase. The yield of the reaction product obtained was 3,949 g. Its peak molecular weight was 2,453 and its weight average molecular weight was 3,788. Its polydispersity Mw/Mn was 1.29. IR spectroscopy indicated a total carbonate content of the PEC polyol of 8.8 weight % CO₃. ¹H NMR revealed a ratio of polyethercarbonate segments (A):polycarbonate segments (B):and polyether segments (C) of 16:2:82.

Examples 3 and 5 demonstrate that, by selectively controlling and/or modifying at least one reaction parameter (increasing the reaction temperature from 110° C. to 130° C. while maintaining a reduced PO concentration in the liquid reaction phase), it is possible to form a PEC polyol and maintain the content of polyethercarbonate segments while specifically decreasing the content of polycarbonate segments from 8% to 2%.

### Small Scale PEC Polyol Example 6

PEC Polyol Example 6 was prepared according to the present invention as follows. An amount of 900 g of the purified H-functional initiator and 20 g of a suspension of the multimetal cyanide compound containing catalyst, described above, were used. The reaction temperature was 110® C and the reactor was pressurized with CO₂ to 700 psi. The propylene oxide monomer (2700 g) was added during 4 hours in a manner that maintained the concentration of the propylene oxide monomer in the liquid reaction phase at 8-10 weight % based on the total weight of the liquid reaction phase. The yield of the reaction product obtained was 4,156 g. Its peak molecular weight was 2,056 and its weight average molecular weight was 3,649. Its polydispersity Mw/Mn was 1.39. IR spectroscopy indicated a total carbonate content of the PEC polyol of 11.9 weight % CO₃. ¹H NMR revealed a ratio of polyethercarbonate segments (A):polycarbonate segments (B):and polyether segments (C) of 18:7:75.

### Small Scale PEC Polyol Example 7

PEC Polyol Example 7 was prepared according to the present invention as follows. An amount of 900 g of the purified H-functional initiator and 20 g of a suspension of the multimetal cyanide compound containing catalyst, described above, were used. The reaction temperature was 110° C. and the reactor was pressurized with CO₂ to 2000 psi during the first 2 hours of PO addition. The propylene oxide monomer (2700 g) was added during 4 hours. The yield of the reaction product obtained was 3,846 g. Its peak molecular weight was 1,833 and its weight average molecular weight was 3,150. Its polydispersity Mw/Mn was 1.37. IR spectroscopy indicated a total carbonate content of the PEC polyol of 7.7 weight % CO₃. ¹H NMR revealed a ratio of polyethercarbonate segments (A):polycarbonate segments (B):and polyether segments (C) of 9:7:85.

Examples 6 and 7 demonstrate that, by selectively controlling and/or modifying at least one reaction parameter (restricting the feed of CO₂ and providing a high concentration of CO₂ only during the first 2 hours of propylene oxide addition), it is possible to form a PEC polyol and maintain the content of polycarbonate segments at 7% while specifically decreasing the content of polyethercarbonate segments from to 18% to 9%.

### Small Scale PEC Polyol Example 8

PEC Polyol Example 8 was prepared according to the present invention as follows. An amount of 900 g of the purified H-functional initiator and 20 g of a suspension of the multimetal cyanide compound containing catalyst, described above, were used. The reaction temperature was 110° C. and the reactor was pressurized with CO₂ to 1400 psi during the first 3 hours of PO addition. The propylene oxide monomer (2700 g) was added during 4 hours. The yield of the reaction product obtained was 4,282 g. Its peak molecular weight was 1,935 and its weight average molecular weight was 3,675. Its polydispersity Mw/Mn was 1.41. RR spectroscopy indicated a total carbonate content of the PEC polyol of 12.0 weight % CO₃. ¹H NMR revealed a ratio of polyethercarbonate segments (A):polycarbonate segments (B):and polyether segments (C) of 15:10:75.

Examples 7 and 8 demonstrate that, by selectively controlling and/or modifying at least one reaction parameter (making CO₂ monomer available during the first 2 or 3 hours of propylene oxide addition, while at the same time adjusting CO₂ monomer concentration in the liquid phase), it is possible to form a PEC polyol and increase total carbonate content, increase the content of polyethercarbonate segments, and increase the content of polycarbonate segments, while maintaining the ratio of polyethercarbonate segments to polycarbonate segments.

### Small Scale PEC Polyol Example 9

PEC Polyol Example 9 was prepared according to the present invention as follows. An amount of 1000 g of the purified H-functional initiator, which is an adduct of glycerine and propylene oxide monomer with a number average molecular weight of 1430, a water content <0.03% and a residual catalyst content <5 ppm, and 200 g of a suspension of the multimetal cyanide compound containing catalyst, described above, were used. The reaction temperature was 60° C. and the reactor was pressurized with CO₂ to 800 psi. The propylene oxide monomer (2400 g) was added during 4 hours in a manner that maintained the concentration of the propylene oxide monomer in the liquid reaction phase at 15 weight % based on the total weight of the liquid reaction phase. The yield of the reaction product obtained was 4,626 g. Its peak molecular weight was 2,272 and its weight average molecular weight was 29,935. Its polydispersity Mw/Mn was 6.8. IR spectroscopy indicated a total carbonate content of the PEC polyol of 23.8 weight % CO₃. ¹H NMR revealed a ratio of polyethercarbonate segments (A):polycarbonate segments (B):and polyether segments (C) of 6:14:80.

Examples 6 and 9 demonstrate that, by selectively controlling and/or modifying at least one reaction parameter (selecting an H-functional initiator having a higher molecular weight, increasing catalyst concentration, lowering reaction temperature, and maintaining an increased concentration of propylene oxide in the reaction mixture), it is possible to form a PEC polyol with double the total carbonate content, while reducing the content of polyethercarbonate segments and increasing the content of polycarbonate segments from 7% to 14%.

### Small Scale PEC Polyol Example 10

PEC Polyol Example 10 was prepared according to the present invention as follows. An amount of 900 g of the purified H-functional initiator and 20 g of a suspension of the multimetal cyanide compound containing catalyst, described above, were used. In addition 14.8 of t-butanol were added as a sterically-hindered chain transfer agent. The reaction temperature was 100-130° C. and the reactor was pressurized with CO₂ to 1400 psi during the first 3 hours of PO addition. The propylene oxide monomer (2700 g) was added during 4 hours. The yield of the reaction product obtained was 4,231 g. Its peak molecular weight was 1,984 and its weight average molecular weight was 2,760. Its polydispersity Mw/Mn was 1.26. IR spectroscopy indicated a total carbonate content of the PEC polyol of 11.8 weight % CO₃. ¹H NMR revealed a ratio of polyethercarbonate segments (A):polycarbonate segments (B):and polyether segments (C) of 15:10:75.

Examples 8 and 10 demonstrate that, by selectively controlling and/or modifying at least one reaction parameter (providing a sterically-hindered chain transfer agent and modifying the temperature during the course of propylene oxide addition and reaction), it is possible to form a PEC polyol and control the polydispersity of the PEC polyol without adversely affecting the overall carbonate composition of the PEC polyol or the ratio of polyethercarbonate segments to polycarbonate segments.

### Large Scale PEC Polyol Example 11

PEC Polyol Example 11 was prepared according to the present invention as follows. An amount of 90 lbs of the purified H-functional initiator and 2 kg of a suspension of the multimetal cyanide compound containing catalyst, described above, were used. The reaction temperature was 65° C. and the reactor was pressurized with CO₂ to 110 psi. The propylene oxide monomer (280 lbs) was added during 24 hours reducing the concentration of propylene oxide monomer in the liquid reaction phase during the course of the addition from 10 to 6 weight % based on the total weight of the liquid reaction phase. The yield of the reaction product obtained was 241 lbs. Its peak molecular weight was 2,673 and its weight average molecular weight was 3,529. Its polydispersity Mw/Mn was 1.22. IR spectroscopy indicated a total carbonate content of the PEC polyol of 12.0 weight % CO₃. ¹H NMR revealed a ratio of polyethercarbonate segments (A):polycarbonate segments (B):and polyether segments (C) of 16:7:77.

Examples 6 and 11 demonstrate that, by selectively controlling and/or modifying at least one reaction parameter (modifying the temperature and pressures in the respective reactors and applying modified addition schemes for the addition of the propylene oxide), it is possible to form PEC polyols with nearly identical carbonate content and with nearly identical content of polyethercarbonate, polycarbonate, and polyether segments, i.e., identical microstructure. Thus, PEC polyols having identical microstructure can be obtained using very different sets of reaction parameters (65° C./110 psi CO₂ vs. 110° C./700 psi CO₂).

Table 1 below summarizes the results for the various Examples.

TABLE 1
Summary

| | | | Chain | Polyethercarbonate | PPC | PEC |
|---|---|---|---|---|---|---|
| | | Temp | CO₃ % | CH₃ | CH₃ | CO₃ % |
| | Initiator | (° C.) | (IR) | (¹HNMR) | (¹HNMR) | (¹HNMR) |
| Small Scale | | | | | | |
| Example | | | | | | |
| 1 | 1 | 130 | 5.8 | 9 | 1 | 90 |
| 2 | 1 | 130 | 7 | 13 | 3 | 84 |
| 3 | 2 | 110 | 12.1 | 19 | 8 | 73 |
| 4 | 2 | 110 | 18 | 11 | 8 | 81 |
| 5 | 2 | 130 | 8.8 | 16 | 2 | 82 |
| 6 | 1 | 110 | 11.9 | 18 | 7 | 75 |
| 7 | 1 | 110 | 7.7 | 9 | 7 | 85 |
| 8 | 1 | 110 | 12 | 15 | 10 | 75 |
| 9 | 3 | 60 | 23.8 | 6 | 14 | 80 |
| 10 | 1 | 100-130 | 11.8 | 15 | 10 | 75 |
| Large Scale | | | | | | |
| Example | | | | | | |
| 1 | 1 | 65 | 12 | 16 | 7 | 77 |

Initiator 1 is a trifunctional polyol formed by adding propylene oxide to a glycerine nucleus and is commercially available from BASF Corporation, Wyandotte, Mich. as Plurocal® GP730. Initiator 2 is a propylene glycol formed by adding propylene oxide to a propylene glycol nucleus and is commercially available from BASF Corporation, Wyandotte, Mich. as Plurocal® P 710. Initiator 3 is a nominal 1500 molecular weight triol and is commercially available from BASF Corporation, Wyandotte, Mich. as Plurocal® P 1135.

The invention has been described in an illustrative manner, and it is to be understood that the terminology which has been used is intended to be in the nature of words of description rather than of limitation. Obviously, many modifications and variations of the present invention are possible in light of the above teachings, and the invention maybe practiced otherwise than as specifically described.

What is claimed is:

1. A method of forming a polyethercarbonate polyol, said method comprising the steps of:
(A) providing a catalyst comprising a multimetal cyanide compound;
(B) reacting an H-functional initiator, an alkylene oxide, and carbon dioxide in the presence of the multimetal cyanide compound in a reactor to form the polyethercarbonate polyol comprising the general formula [A]ₐ[B]_{b}[C]_{c}, wherein,
A is a polyethercarbonate segment, B is a polycarbonate segment, and C is a polyether segment wherein each of A, B, and C are defined by the presence of CH₃ group resonances of alkylene oxide-based ether chain units at separate peaks in a ¹H NMR spectrum of the polyethercarbonate polyol, and
a is a value from 1-98, b is a value from 0-60, and c is a value from 0-98 so long as b and c are not both equal to 0,
with the values for each of a, b, and c in area % based on the presence of the CH₃ group resonances in the ¹H NMR spectrum and on the integration of the area under the respective peaks that are present in the ¹H NMR spectrum; and
(C) selectively controlling the value of a, b, or c.

2. A method as set forth in claim 1 wherein the value of a is from 5-80, the value of b is from 1-40, and the value of c is from 20-95.

3. A method as set forth in claim 2 wherein the value of a is from 5-35, the value of b is from 5-18, and the value of c is from 65-95.

4. A method as set forth in claim 1 wherein the polyethercarbonate segment, A, comprises the general formula [—CO₂-(AO)ₓ—CO₂-(AO)_{y}—] wherein,
CO₂ is a carbon dioxide monomer and AO is an alkylene oxide monomer,
x is a value >1 and y is a value >1, and
a molar ratio of AO:CO₂ is >1.

5. A method as set forth in claim 4 further comprising the step of selectively controlling the value of x, the value of y, or the molar ratio of AO:CO₂.

6. A method as set forth in claim 1 wherein the polyether segment, C, comprises the general formula [-AO-(AO)_{z}-AO—] wherein,
AO is an alkylene oxide monomer, and
z is a value >0.

7. A method as set forth in claim 6 further comprising the step of selectively controlling the value of z.

8. A method as set forth in claim 1 wherein the polyethercarbonate polyol is formed according to a variety of reaction parameters and the step of selectively controlling the value of a, b, or c comprises modifying at least one of the reaction parameters to selectively control the value of a, b, or c.

9. A method as set forth in claim 8 wherein the step of modifying at least one of the reaction parameters comprises modifying a temperature of the reactor between 40 and 180° C.

10. A method as set forth in claim 8 wherein the step of modifying at least one of the reaction parameters comprises modifying a pressure of the reactor between 10 and 3000 psi.

11. A method as set forth in claim 8 wherein the step of modifying at least one of the reaction parameters comprises modifying a concentration of the multimetal cyanide compound, modifying a concentration of the H-functional initiator, modifying a concentration of the alkylene oxide, or modifying a concentration of the carbon dioxide.

12. A method as set forth in claim 8 further comprising the step of charging the reactor with the H-functional initiator and the multimetal cyanide compound.

13. A method as set forth in claim 12 wherein the step of reacting the H-functional initiator, the alkylene oxide, and carbon dioxide comprises feeding the alkylene oxide into the reactor over a length of time.

14. A method as set forth in claim 13 wherein the step of modifying at least one of the reaction parameters comprises ramping up or down a rate that the alkylene oxide is fed into the reactor over the length of time.

15. A method as set forth in claim 13 wherein the step of feeding the alkylene oxide into the reactor over the length of time comprises feeding the alkylene oxide into the reactor over at least 2 hours.

16. A method as set forth in claim 15 wherein the step of modifying at least one of the reaction parameters comprises extending the length of time that the alkylene oxide is fed into the reactor.

17. A method as set forth in claim 13 wherein the step of reacting the H-functional initiator, the alkylene oxide, and carbon dioxide further comprises pressurizing the reactor with carbon dioxide.

18. A method as set forth in claim 17 wherein the carbon dioxide is pressurized after the feeding of the alkylene oxide into the reactor.

19. A method as set forth in claim 17 wherein the carbon dioxide is pressurized during the feeding of the alkylene oxide into the reactor.

20. A method as set forth in claim 19 further comprising the step of selectively restricting an availability of the carbon dioxide for at least a portion of the length of time that the alkylene oxide is fed into the reactor.

21. A method as set forth in claim 13 wherein the step of modifying at least one of the reaction parameters comprises ramping up or down a temperature of the reactor during the feeding of the alkylene oxide into the reactor.

22. A method as set forth in claim 1 wherein the step of reacting the H-functional initiator, the alkylene oxide, and carbon dioxide comprises reacting an H-functional initiator having a number-average molecular weight, Mn, of from 92 to 2000 Dalton with the alkylene oxide and carbon dioxide.

23. A method as set forth in claim 1 wherein the step of reacting the H-functional initiator, the alkylene oxide, and carbon dioxide comprises reacting an H-functional initiator having a polydispersity of from 1.0 to 5.0 with the alkylene oxide and carbon dioxide.

24. A method as set forth in claim 1 wherein the H-functional initiator has a functionality of from 1 to 8.

25. A method as set forth in claim 8 wherein the step of modifying at least one of the reaction parameters comprises agitating the reactor during the reacting of the H-functional initiator, the alkylene oxide, and carbon dioxide.

26. A method as set forth in claim 8 wherein the step of modifying at least one of the reaction parameters comprises providing a sterically-hindered chain transfer agent.

27. A method as set forth in claim 26 wherein the H-functional initiator, the alkylene oxide, and carbon dioxide are reacted in the presence of the sterically-hindered chain transfer agent, in addition to the multimetal cyanide compound.

28. A method as set forth in claim 26 wherein the sterically-hindered chain transfer agent is selected from the group of a sterically-hindered alcohol, a sterically-hindered phenol, a sterically-hindered benzoic acid, a sterically-hindered thiol, and combinations thereof.

29. A method as set forth in claim 1 wherein the catalyst further comprises at least one of: an organic complexing agent; water; a polyether; and a surface-active substance.

30. A method as set forth in claim 29 wherein the multimetal cyanide compound has a crystalline structure and a content of platelet-shaped particles of at least 30% by weight, based on a weight of the multimetal cyanide compound.

31. A method as set forth in claim 8 wherein the step of modifying at least one of the reaction parameters comprises activating the catalyst.

32. A method as set forth in claim 31 wherein the step of activating the catalyst comprises removing free water and catalyst bound water from the reactor.

33. A method as set forth in claim 31 wherein the step of activating the catalyst further comprises removing activity-reducing, catalyst site blockers from a surface of the catalyst.

34. A method as set forth in claim 1 further comprising the step of restricting an amount of water in the reactor.

35. A method as set forth in claim 34 wherein the step of restricting the amount of water in the reactor comprises restricting the amount of water in the reactor to <100 ppm.

36. A method as set forth in claim 34 wherein the step of restricting the amount of water in the reactor comprises restricting the amount of water in the reactor to <10 ppm.

37. A method as set forth in claim 1 wherein the alkylene oxide is propylene oxide.
